(19) United States
(12) Patent Application Publication
(10) Pub. No.: US 2006/0212534 A1
(43) Pub. Date: Sep. 21, 2006

(54) Method and system of providing a personal audio/video broadcasting architecture

(75) Inventor: Bo Wu, San Jose, CA (US)

Correspondence Address: MCDERMOTT WILL & EMERY LLP, 18191 VON KARMAN AVE., SUITE 500, IRVINE, CA, 92612-7108, US

(73) Assignee: EnReach Technology, Inc., Santa Clara, CA (US)

(21) Appl. No.: 11/080,162

(22) Filed: Mar. 15, 2005

(51) Int. Cl. G06F 15/16

(52) U.S. Cl. 709/217; 709/227

(57) ABSTRACT

A system for providing customized audio/video (A/V) and animation programming over a network is disclosed. The system includes a client configured to allow a user to specify a content portal page and a server configured to: store a plurality of content files, each of the plurality of content files including A/V and/or animation data, receive the content portal page from the client, create a personalized program based on the content portal page, the personalized program including one or more of the plurality of content files, and transmit the personalized program to the client. The client is further configured to execute the personalized program for consumption by the user. The personalized program is executed such that the one or more of the plurality of content files included in the personalized program are shown to the user in a continuous manner.

### CROSS-REFERENCE(S) TO RELATED APPLICATION(S)

Not Applicable.

### STATEMENT AS TO RIGHTS TO INVENTIONS MADE UNDER FEDERALLY SPONSORED RESEARCH OR DEVELOPMENT

Not Applicable.

### BACKGROUND OF THE INVENTION

The present invention generally relates to audio/video programming, and in particular to methods and systems for providing a personal audio/video broadcasting architecture.

With evolving technologies constantly improving bandwidth and capacity, computer servers and clients are able to handle increasing amount of video/audio (A/V) and animation data over the Internet. As a result, more and more A/V and animation data is becoming readily accessible on websites for consumption by users.

Many websites are now equipped with the capability to display A/V and animation data. For example, many news-oriented websites not only provide written news articles, they also have corresponding A/V and animation clips associated with such articles. Users may simply click on the appropriate hyperlinks to activate the A/V and animation clips.

Even though A/V and animation data is now commonly available to users on websites, groups of such data corresponding to various topics are very disjointed in nature. In other words, users are required to access such groups of data separately. For example, at a typical news-oriented website, if a user desires to see two (2) A/V clips associated with two (2) different articles, the user will have to separately activate the corresponding hyperlinks.

In addition, since the selection of A/V and animation data for viewing is done manually by a user, the availability of certain A/V and animation data may not be readily apparent to the user. This is because a website is typically made up of multiple sections and web pages. A user browsing through a website may easily bypass or miss hyperlinks corresponding to A/V and animation data that the user might otherwise be interested in viewing.

Furthermore, A/V and animation data that is available on websites is generally not tailored to the specific needs or desires of a particular user. Typically, the same A/V and animation data is made available to all qualified users for access and viewing.

Hence, it would be desirable to provide methods and systems that are capable of, amongst other things, providing video/audio programming that is personally customized for a specific user.

### SUMMARY OF THE INVENTION

A system for providing customized audio/video (A/V) and animation programming over a network is disclosed. In one embodiment, the system includes a client configured to allow a user to specify a content portal page and a server configured to: store a number of content files, each of the content files including A/V and animation data, receive the content portal page from the client, create a personalized program based on the content portal page, the personalized program including one or more content files, and transmit the personalized program to the client. The client is further configured to execute the personalized program for consumption by the user. The personalized program is executed such that the one or more content files included in the personalized program are shown to the user in a continuous manner.

In another embodiment, a system for providing customized audio/video (A/V) and animation programming over a network includes a client configured to allow a user to specify a content portal page and a server configured to: store a number of content files, each of the content files including A/V and animation data, receive the content portal page from the client, retrieve one or more content files based on the content portal page, and transmit the retrieved one or more content files to the client. The client is further configured to: merge the one or more content files to create a personalized program based on the content portal page, and execute the personalized program for consumption by the user. The personalized program is executed such that the one or more content files are shown to the user in a continuous manner.

In a further embodiment, a system for providing customized audio/video (A/V) and animation programming over a network includes a client configured to allow a user to specify a content portal page, and a number of servers, each server configured to store a number content files, each of the content files including A/V and animation data. A first one of the servers is configured to: receive the content portal page from the client, create a personalized program based on the content portal page, the personalized program including one or more content files retrieved from the servers, and transmit the personalized program to the client. The client is further configured to execute the personalized program for consumption by the user. The personalized program is executed such that the one or more content files included in the personalized program are shown to the user in a continuous manner.

In yet another embodiment, a server for providing customized audio/video (A/V) and animation programming over a network is disclosed. The server includes memory configured to store a number of content files, each of the content files including A/V and/or animation data; content processing logic configured to: receive a content portal page, create a personalized program based on the content portal page, the personalized program including one or more of the content files, and transmit the personalized program. The content portal page is specified by a user using a client. The personalized program is executable by the client for consumption by the user. The personalized program is executed such that the one or more of the plurality of content files included in the personalized program are shown to the user in a continuous manner.

In yet another embodiment, a server for providing customized audio/video (A/V) and animation programming over a network is disclosed. The server includes memory configured to store a number of content files, each of the content files including A/V and/or animation data, and content processing logic configured to: receive a content portal page from a client, wherein the content portal page is specified by a user using the client, retrieve one or more content files based on the content portal page, and transmit the one or more content files to the client. The one or more content files are usable by the client to create a personalized program based on the content portal page. The personalized program is executable by the client for consumption by the user. When the personalized program is executed, the one or more content files are shown to the user in a continuous manner.

In a further embodiment, a client for providing customized audio/video (A/V) and animation programming over a network is disclosed. The client includes content processing logic configured to: allow a user to specify a content portal page, transmit the content portal page to a server, receive a personalized program from the server, wherein the personalized program is created based on the content portal page, the personalized program including one or more content files selected from a number of content files, each of the content files including A/V and/or animation data, and execute the personalized program for consumption by the user. The personalized program is executed such that the one or more content files included in the personalized program are shown to the user in a continuous manner.

In yet another embodiment, a client for providing customized audio/video (A/V) and animation programming over a network is disclosed. The client includes content processing logic configured to: allow a user to specify a content portal page, transmit the content portal page to a server, receive one or more content files from the server, the one or more content files selected from a number of content files based on the content portal page, each of the content files including A/V and/or animation data, merge the one or more content files to create a personalized program based on the content portal page, and execute the personalized program for consumption by the user. The personalized program is executed such that the one or more content files are shown to the user in a continuous manner.

In one aspect, a method for providing customized audio/video (A/V) and animation programming over a network is disclosed. The method includes configuring a server to: store a number of content files, each of the content files including A/V and/or animation data, receive a content portal page, create a personalized program based on the content portal page, the personalized program including one or more content files, and transmit the personalized program, and configuring a client to: allow a user to specify the content portal page, transmit the content portal page to the server, receive the personalized program from the server, and execute the personalized program for consumption by the user. The personalized program is executed such that the one or more content files included in the personalized program are shown to the user in a continuous manner.

In another aspect, a method for providing customized audio/video (A/V) and animation programming over a network is disclosed. The method includes configuring a client to allow a user to specify a content portal page, configuring a server to: store a number of content files, each of the content files including A/V and/or animation data, receive the content portal page from the client, retrieve one or more content files based on the content portal page, and transmit the retrieved one or more content files to the client, and further configuring the client to: merge the one or more content files to create a personalized program based on the content portal page, and execute the personalized program for consumption by the user. The personalized program is executed such that the one or more content files are shown to the user in a continuous manner.

In a further aspect, a method for providing customized audio/video (A/V) and animation programming over a network is disclosed. The method includes configuring each of a number of servers to store a number of content files, each of the content files including A/V and/or animation data, configuring a first one of the servers to: receive the content portal page, create a personalized program based on the content portal page, the personalized program including one or more content files retrieved from the servers, and transmit the personalized program, and configuring a client to: allow a user to specify the content portal page, transmit the content portal page to the first one of the servers, receive the personalized program, and execute the personalized program for consumption by the user. The personalized program is executed such that the one or more content files included in the personalized program are shown to the user in a continuous manner.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

Aspects, advantages and novel features of the present invention will become apparent from the following description of the invention presented in conjunction with the accompanying drawings:

FIG. 1 is a simplified schematic diagram illustrating one embodiment of the present invention; and

FIG. 2 is a simplified schematic diagram illustrating another embodiment of the present invention.

### DETAILED DESCRIPTION OF SPECIFIC EMBODIMENTS

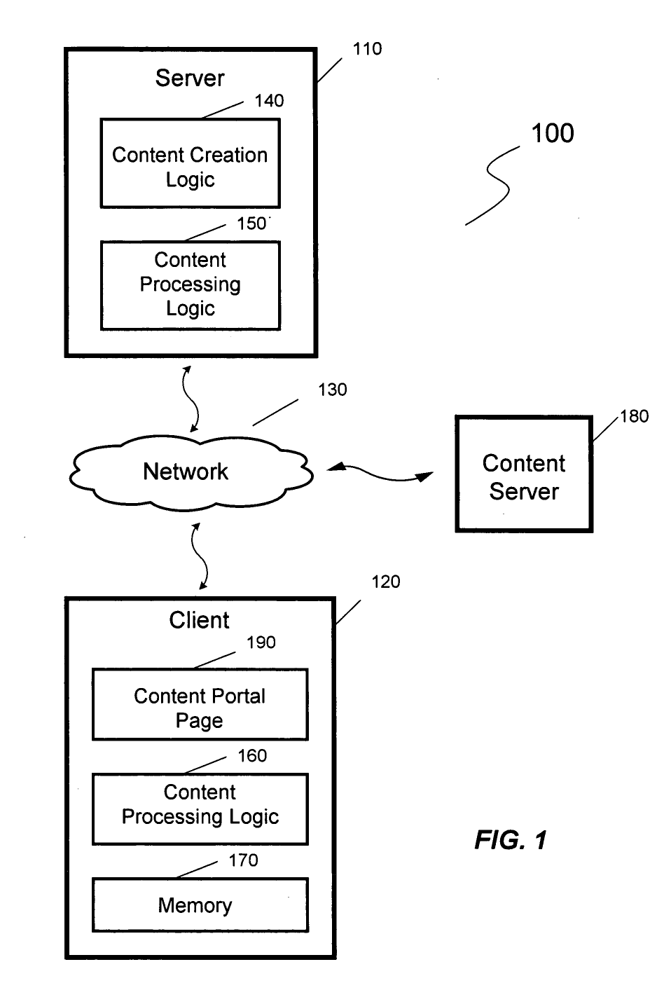

One or more embodiments of the present invention will now be described. FIG. 1 illustrates one embodiment of the present invention. As shown in FIG. 1, the system 100 includes a server 110 and a client 120. The server 110 and the client 120 are interconnected via a computer network 130. The client 120 may include, for example, television set top boxes, a DVD player, a media player, a media center, a cellular phone, a personal digital assistant (PDA), a personal computer, etc. The computer network 130 may include, for example, the Internet, wireless communications networks, radio frequency communications networks, satellite communications networks, etc. Communications between the client 120 and the computer network 130 may be achieved in a number of different ways including, for example, TCP/IP protocol, WiFi, WiMax, DVB-C/DVB-T/DVB-S/DVB-H, ATSC, etc.

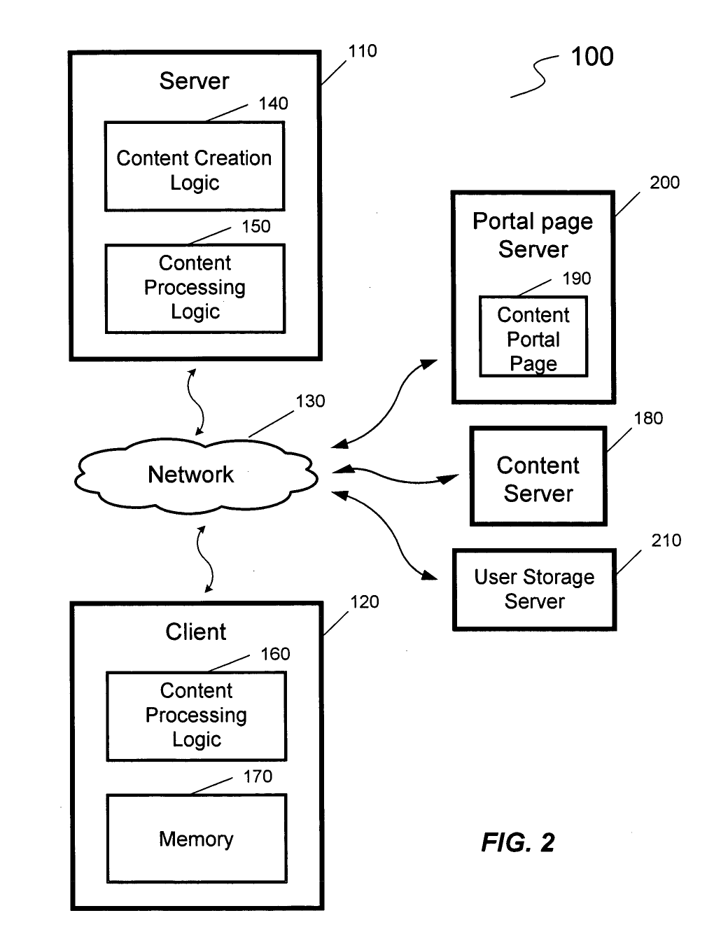

The server 110 further includes content creation logic 140 and content processing logic 150. Similarly, the client 120 includes corresponding content processing logic 160. As will be further described below, the content creation logic 140 may be used to create contents that are suitable for use with the system 100. The content processing logic 150, 160 residing respectively on the server 110 and the client 120 may then interact with each other to customize, retrieve and/or display contents designed for a specific user. The contents designed for a specific user may be stored on a memory 170 in the client 20. In an alternative embodiment as shown in FIG. 2, the contents designed for a specific user may be stored on a user storage server 210 for subsequent retrieval.

The content creation logic 140 may be used to create contents that are suitable for use with the system 100. Original contents including, for example, A/V and/or animation data, may be supplied from a variety of sources. For example, some original contents may be supplied by news organizations, such as, Associated Press, CNN (Cable News Network), New York Times, etc. The content creation logic 140 may be used to generate a variety of meta data associated with the original contents.

The original contents may be organized in a number of different ways. For example, the original contents may be organized into corresponding content files. Each content file may include A/V and/or animation data relating to a particular story, topic or subject. A variety of meta data may be included with each content file, as will be further described below. The content creation logic 140 may be used to generate or include the meta data for a content file. For example, the content creation logic 140 may include a user interface that allows an administrator to generate meta data for a content file. Additionally, the content creation logic 140 may extract or derive meta data for a content file on an automated basis; the meta data for a content file may be supplied by the source or provider of the content file.

One type of meta data that can be included with a content file is rating meta data. The rating meta data for a content file may represent a rating assigned to the content contained in the content file. The rating is determined based on the content. For example, if the content file contains adult content, a rating of “MA” representing content suitable only for mature audience may be assigned; alternatively, if the content file content general content, a rating of “G” representing content suitable for general audience may be assigned. A rating system similar to the one applied to television broadcasts and movies may be used. Based on the disclosure and teaching provided herein, it should be noted that other types of rating system may be used. It should be further noted that the original content may already contain rating information. For example, if the original content is a movie, rating information associated with that movie may be supplied by the source. Such rating information may then be extracted by the content creation logic 140 to be included in the content file.

One type of meta data that can be included with a content file is summary meta data. The summary meta data for a content file may represent a summary of the content contained in the content file. The content creation logic 140 may be used to allow an administrator to enter the summary meta data. Additionally, the content creation logic 140 may extract or derive the summary meta data from one or more sources. For example, the original content may already contain certain summary information, such as, a one-sentence summary of a news story. The content creation logic 140 may include part or all of the summary information in the content file.

One type of meta data that can be included with a content file is summary audio meta data. The summary audio meta data for a content file may represent a summary of the audio content contained in the content file. For example, the summary audio meta data may include audio clips of various sound tracks or songs contained in the content file.

One type of meta data that can be included with a content file is content length meta data. The content length meta data for a content file may represent length information on the video and/or audio content in the content file. The content length meta data may be used in a number of ways. For example, the content length meta data may include information on the length of various video and/or audio segments or chapters in the content file. As will be further described below, various content files or portions thereof may be combined to form a personalized program. The content length meta data from various content files may be used to calculate the total length of such personalized program.

One type of meta data that can be included with a content file is start audio volume meta data. The start audio volume meta data for a content file may represent the appropriate audio volume to be used for initially playing the audio content. The start audio volume meta data may be used in a number of ways. For example, different sound effects may be associated with different contents and, as a result, different audio volume may be used accordingly. As noted above, since various content files or portions thereof may be combined to form a personalized program, the audio levels of corresponding content files may need to be synchronized or consistent in order to make the personalized program more enjoyable.

One type of meta data that can be included with a content file is time meta data. The time meta data for a content file may represent time information relating to when the content is created, recorded or reported. The time meta data may be used in a number of ways, such as, identifying content files in a chronological order. For example, if the content relates to a news item, the time meta data may be used to indicate when the news items was reported. Also, since various content files or portions thereof may be combined to form a personalized program, the time meta data may be used to arrange the content files included in the personalized program on a chronological basis.

One type of meta data that can be included with a content file is video brightness meta data. The video brightness meta data for a content file may represent the appropriate video information to be used for initially playing the video content. The video brightness meta data may be used in a number of ways. For example, different video effects may be associated with different contents. Since various content files or portions thereof may be combined to form a personalized program, the video brightness levels of corresponding content files may need to be synchronized or consistent in order to make the personalized program more enjoyable.

One type of meta data that can be included with a content file is location meta data. The location meta data for a content file may represent information relating to locations as identified in the content file. For example, if the content file relates to a specific geographic location, the location meta data may include information on that specific geographical location. The location meta data may be used in a number of ways. For example, if it is determined that the client 120 is located in a specific geographic area (such determination can be made via, for example, GPS (Global Positioning System)), the location meta data can be used to retrieve content files that are relevant to such geographic area. In one application, the relevant content files can be displayed to a user of the client 120 during a sightseeing trip to a particular area.

One type of meta data that can be included with a content file is advertising meta data. The advertising data for a content file may represent advertisement information relating to products and/or services that are described in the content file. Such advertisement information may include, for example, product and service information, pricing information, special offers, etc. Furthermore, the advertising meta data may be time- and/or location-based. The advertising meta data may be used in a number of ways. For example, the advertising meta data may be used to identify content files that offer certain products and/or services based on a number of criteria, such as, products and/or services offered, duration and location of sale. A personalized infomercial program including a number of related content files may be compiled to suit the specific buying needs of a user.

One type of meta data that can be included with a content file is e-commerce meta data. The e-commerce meta data for a content file may represent any information that can be used to conduct electronic commerce. Such information may be time- and/or location-based and may include, for example, vendor information, system compatibility information, etc.

One type of meta data that can be included with a content file is language meta data. The language meta data for a content file may represent information relating to available languages that are associated with the contents of the content file. For example, the language meta data may include information relating to multiple sub-titles and alternative language audio tracks. Furthermore, the language meta data may be time- and/or location-based. The language meta data may be used in a number of ways. For example, a personalized program in a particular language can be created by identifying and compiling a number of related content files based on their respective language meta data.

One type of meta data that can be included with a content file is effect meta data. The effect meta data may represent information relating to the visual and/or audio effects that are associated with the contents of the content file. For example, the effect meta data may include information relating to various styles. The effect meta data may be used in a number of ways. For example, the effect meta data may be used by the client 120 to determine how to display and/or play the content of the corresponding content file. The client 120 may display and/or play the content based on either some predefined criteria or other criteria as prescribed by the client 120.

One type of meta data that can be included with a content file is subject channel meta data. The subject channel meta data for a content file may represent information relating to the source of the content file. The subject channel meta data may be used in a number of ways. For example, the subject channel meta data may be used to compile a personalized program that include a number of content files coming from the same source.

One type of meta data that can be included with a content file is content type meta data. The content type meta data for a content file may represent information relating to the genre or category associated with the content of the content file. For example, the content type meta data may indicate that a particular content file falls into the “news” category. The content type meta data may be used in a number of ways. For example, the content type meta data may be used to compile a personalized program that include a number of content files belonging to the same genre or category.

One type of meta data that can be included with a content file is alarm meta data. The alarm meta data for a content file may represent information that can be used to alert a user of the content file. The alarm meta data may be time- and/or location-based. The alarm meta data may be used in a number of ways. For example, the alarm meta data may be used to alert one or more users via their clients 120 to view the corresponding content file at a certain time and/or when the clients 120 are located in a particular geographical location. The content file may involve, for example, a breaking news story; alternatively, the content file may require concurrent participation from various users, such as, a cooperative game that requires multiple players.

One type of meta data that can be included with a content file is DRM (digital rights management) meta data. The DRM meta data for a content file may represent information relating to how the content file may be accessed and/or modified. The DRM meta data may include authentication information, access conditions, user rights, etc. The DRM meta data may be used in a number of ways. For example, the DRM meta data may be used to determine if a particular user has the rights to access and/or modify the content file. Conversely, the DRM meta data can be used to determine if a particular user is able to include a content file in his/her personalized program.

One type of meta data that can be included with a content file is related link and content meta data. The related link and content meta data for a content file may represent information pertaining to hyperlinks and other related content files that are associated with the content file. The related link and content meta data may be used in a number of ways. For example, the related link and content meta data may be used to provide hyperlink information for viewing by a user of the content file, thereby allowing the user to obtain information on other websites that may be relevant to the content file; similarly, the related link and content meta data may also be used to provide information on other related content files, thereby allowing the user to obtain information on other content files that might also be of interest to the user.

One type of meta data that can be included with a content file is content-specific meta data. The content-specific meta data for a content file may represent any miscellaneous information relating to the content of the content file. For example, the content-specific meta data may include general background information, actor biographical information, topical information, etc. The content-specific meta data may be used in a number of ways. For example, the content-specific meta data may be used to allow a user to identify content files that share certain common characteristics, such as, content files that involve a particular actor or person.

One type of meta data that can be included with a content file is statistical report meta data. The statistical report meta data for a content file may represent statistical information relating to usage of the content file. For example, the statistical report meta data may include information on number of times the content file has been accessed or viewed, most recent access dates and times, identity of users who accessed the content file, etc. The statistical report meta data may be used in a number of ways. For example, the statistical report meta data may be reported back to the source providing the content file to allow the source to perform various types of analyses, such as, viewer behavior analysis. The statistical report meta data may also be used by a user to compile a personalized program conforming to certain criteria specified by the user. For example, the statistical report meta data may be used to identify the most frequently viewed content files on a particular topic.

One type of meta data that can be included with a content file is feedback meta data. The feedback meta data for a content file may represent information relating to viewer reaction, comment and feedback on the content file. For example, the feedback meta data may include rating information or comments provided by the viewers. The feedback meta data may be used in a number of ways. For example, the feedback meta data may be used by a user to identify and compile a personalized program that includes the most popular content files on a particular topic.

The various types of meta data and their respective usage described above are not meant to be exhaustive. Based on the disclosure and teachings provided herein, a person of ordinary skill in the art will understand that other types of meta data may be included and used according to the present invention.

The content files and their respective meta data may be stored on a content server 180 associated with the server 110. The content server 180 may be accessed by the server 110 via the computer network 130; alternatively, the server 110 may access the content server 180 via a direct connection (not shown) without going through the computer network 130. The content creation logic 140 may index the content files based on the various types of meta data associated with the content files. The indexed content files may be searched and accessed by a portal engine or a search engine (not shown) associated with the server 110.

The content processing logic 150 and 160 residing respectively on the server 110 and the client 120 collectively facilitate compilation, distribution and showing of a personalized program based on the indexed content files.

In order to create a personalized program based on the indexed content files, a user may utilize the client 120 to create a content portal page 190. The content processing logic 160 residing on the client 120 allows the user to specify a number of criteria and/or parameters for his/her content portal page 190. In one implementation, the content processing logic 160 may provide a personal program construction/definition language to allow the user or an administrator to create the content portal page 190. The criteria and/or parameters may define the content files that the user wishes to see. For example, the criteria and/or parameters that can be specified by the user include a specific rating, a particular type of content, time, etc. Furthermore, the criteria and/or parameters may be used to effect other miscellaneous options and/or features specified by the user, the server 110 and/or the client 120 in connection with the personalized program including, for example, how the personalized program is to be shown. The content portal page 190 and the specified criteria and/or parameters may then be stored on either the client 120 or a portal page server 200 as shown in FIG. 2. It should be further noted that some of the criteria and/or parameters may be provided in real-time when the corresponding content file is ready to be merged and shown as part of a personalized program.

Each user may create and have multiple content portal pages 190. These multiple content portal pages 190 may be stored respectively on different servers and clients. In the situation where in the multiple content portal pages 190 are stored respectively on different servers and clients, the user may synchronize these various content portal pages 190 across the different servers and clients. For example, a user may have a content portal page 190 created on a server hosting a first website and another content portal page 190 created on another server hosting a second website. The user may use his/her client to synchronize the two content portal pages 190 on the two websites.

The content portal page 190 may then be forwarded to the server 110 for further processing. The content processing logic 150 residing on the server 100 may then use the content portal page 190 to identify the appropriate content files from the indexed content files stored in the database 190. The meta data associated with the indexed content files may be checked against the specified criteria and/or parameters associated with content portal page 190 to identify the corresponding content files that conform to the specified criteria and/or parameters.

The identified content files may then be merged or compiled to form the personalized program. The merging or compilation of the identified content files to form the personalized program may be performed by either the server 110 or the client 120. If performed by the server 110, the personalized program is then forwarded to the client 120 for consumption by the user. If performed by the client 120, the identified content files are forwarded to the client 120 and the client 120, in turn, creates the personalized program accordingly based on the content portal page 190.

Content distribution and communications between the server 110 and the client 120 may be conducted in a number of ways. Based on the disclosure and teachings provided herein, a person of ordinary skill in the art will know of various methods and/or ways to achieve such content distribution and communications according to the present invention.

The specified criteria and/or parameters associated with the content portal page 190 and the meta data associated with the identified content files may be used to perform the merging or compilation and showing of the personalized program. For example, using the start audio volume and video brightness meta data, all the content files included in the personalized program may be merged with the same audio volume and video brightness so as to provide a consistent feel to the user.

The specified criteria and/or parameters and/or meta data can be used to effect various customized features and controls with respect to the personalized program. A number of illustrative examples are as follows: (1) certain video segments, parts of a video display or video artifacts may be rendered to remain hidden; (2) scene changes and graphics effects for each content file in the personalized program may be individually controlled; (3) PIP (picture-in-picture) effects or multiple video windows for corresponding content files and associated audio effects may be used; (4) a content rating filter may be used to selectively monitor and control types of content files that can be included in the personalized program; (5) summary segment (including, for example, animated graphics, video segments and/or background audio, etc.) associated with each content file may be shown prior to showing the content file; (6) program ending segments may be defined; (7) graphical effects (including, for example, scrolling text styles and contents, etc.) may be used; (8) advertising information, personalized or otherwise, (including, for example, logos, graphics, etc.) may be included; (9) display of advertising information may be tailored or customized (including, for example, inserting full or partial screen advertising); (10) all or portions of a content file (including, for example, a video segment, an audio track, etc.) may be shown as part of a personalized program; (11) hyperlink information may be dynamically included with the showing of a corresponding content file based on one or more factors (including, for example, time and location of the client 120); (12) a user may activate a hyperlink that is displayed during the showing of a personalized program and be directed to the corresponding website or given additional information relating to the hyperlink; (13) various types of information may be shown during a personalized program based on one or more factors (including, for example, time and location of the client 120); (14) one or more of the content files included in a personalized program may be stripped of certain types of information (including, for example, advertising information); (15) content files for a personalized program may be selected based on desired program length; (16) content files for a personalized program may be selected based on desired subject areas (such as, general news, technology news, sports news, etc.); (17) continued subsequent viewing of a personalized program is available if execution of the personalized program is interrupted; and (18) interactive information (including, for example, viewer feedback and comments) can be captured during execution of a personalized program and such information can then be forwarded to the respective providers of the content files for evaluation purposes.

After the content processing logic 150 creates the personalized program based on the content portal page 190, the personalized program is then forwarded to the client 120 for further processing. When the client 120 receives the personalized program from the server 110, the content processing logic 160 may further process and execute the personalized program based on the content portal page 190 and the meta data associated with the relevant content files for consumption by the user.

In alternative embodiments, after the content processing logic 150 has identified and retrieved all the relevant content files based on the content portal page 190, the retrieved content files are forwarded to the client 120 for further processing. Upon receiving all the relevant content files, the content processing logic 160 creates the personalized program based on the content portal page 190 and subsequently executes the personalized program for consumption by the user.

By using the system 100 as described above, a user is able to design A/V and/or animation programming to his/her own liking based on content files that are available from different sources. Instead of requiring a user to find and retrieve individual content files for viewing, the system 100 may collect the desired content files and present them in a personalized program in a manner as specified by the user.

Furthermore, the viewing experience of the user is substantially enhanced. For example, the system 100 may allow a user to exercise control over which portions of a content file and how such portions are to be shown. Also, instead of having to view the individual content files in a disjointed manner, the content files included in a personalized program may be shown in a continuous and consistent manner. Such customized A/V and/or animation programming would be similar to a television broadcast that had been tailored specifically for a particular user or viewer.

It should be noted that, in other embodiments, the client 120 may be configured to create and store a number of different content portal pages for different users, thereby allowing different users to use the client 120 to view their respective personalized programs.

It should be further noted that, in some embodiments, the system 100 may include two or more servers 110. Content files may be distributed and stored on different servers. Upon receiving a content portal page 190 from the client 120, the content processing logic 150 of the server 120 may, if appropriate, communicate with other servers to coordinate the identification and collection of the relevant content files based on the content portal page 190. Once the relevant content files are retrieved from the corresponding servers, the content processing logic 150 may either merge the retrieved content files to create the personalized program or forward the retrieved content files to the client 120 to allow the client 120 to create the personalized program.

The methods or algorithms described in connection with the embodiments disclosed herein may be embodied directly in hardware, in a software module executable by a processor, or in a combination of both, in the form of control logic, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description of the disclosed embodiments is provided for purposes of illustration and description to enable any person skilled in the art to make or use the present invention. It is not intended to be exhaustive or to limit the invention to the precise form disclosed. Various modifications to these embodiments will be readily apparent to those skilled in the art, and the generic principles defined herein may be applied to other embodiments without departing from the spirit of scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more”. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for”.

What is claimed is:

1. A system for providing customized audio/video (A/V) and animation programming over a network, the system comprising:
a server configured to:
store a plurality of content files, each of the plurality of content files including A/V and/or animation data;
receive a content portal page;
create a personalized program based on the content portal page, the personalized program including one or more of the plurality of content files; and
transmit the personalized program; and
a client configured to:
allow a user to specify the content portal page;
transmit the content portal page to the server;
receive the personalized program from the server; and
execute the personalized program for consumption by the user;
wherein the personalized program is executed such that the one or more of the plurality of content files included in the personalized program are shown to the user in a continuous manner.

2. The system of claim 1 wherein the content portal page includes a plurality of criteria;
wherein each of the plurality of content files includes meta data; and
wherein the meta data associated with the plurality of content files are checked against the plurality of criteria to determine the one or more of the plurality of content files included in the personalized program.

3. The system of claim 2 wherein the server is further configured to create the personalized program based on the respective meta data associated with the one or more of the plurality of content files.

4. The system of claim 2 wherein execution of the personalized program is dynamic and is based on one or more factors.

5. The system of claim 4 wherein the one or more factors include time.

6. The system of claim 4 wherein the one or more factors include location of the client.

7. The system of claim 2 wherein the meta data associated with at least one of the plurality of content files includes rating meta data.

8. The system of claim 2 wherein the meta data associated with at least one of the plurality of content files includes summary meta data.

9. The system of claim 2 wherein the meta data associated with at least one of the plurality of content files includes content length meta data.

10. The system of claim 2 wherein the meta data associated with at least one of the plurality of content files includes summary audio meta data.

11. The system of claim 2 wherein the meta data associated with at least one of the plurality of content files includes time meta data.

12. The system of claim 2 wherein the meta data associated with at least one of the plurality of content files includes location meta data.

13. The system of claim 2 wherein the meta data associated with at least one of the plurality of content files includes advertising meta data.

14. The system of claim 2 wherein the meta data associated with at least one of the plurality of content files includes e-commerce meta data.

15. The system of claim 2 wherein the meta data associated with at least one of the plurality of content files includes language meta data.

16. The system of claim 2 wherein the meta data associated with at least one of the plurality of content files includes effect meta data.

17. The system of claim 2 wherein the meta data associated with at least one of the plurality of content files includes content type meta data.

18. The system of claim 2 wherein the meta data associated with at least one of the plurality of content files includes DRM (digital rights management) meta data.

19. The system of claim 2 wherein the meta data associated with at least one of the plurality of content files includes statistical report meta data.

20. The system of claim 2 wherein the meta data associated with at least one of the plurality of content files includes feedback meta data.

21. The system of claim 1 wherein the client includes one of a mobile device and a personal computer.

22. A system for providing customized audio/video (A/V) and animation programming over a network, the system comprising:
a client configured to allow a user to specify a content portal page; and
a server configured to:
store a plurality of content files, each of the plurality of content files including A/V and/or animation data;
receive the content portal page from the client;
retrieve one or more of the plurality of content files based on the content portal page; and
transmit the retrieved one or more of the plurality of content files to the client;
wherein the client is further configured to:
merge the one or more of the plurality of content files to create a personalized program based on the content portal page; and
execute the personalized program for consumption by the user; and
wherein the personalized program is executed such that the one or more of the plurality of content files are shown to the user in a continuous manner.

23. The system of claim 22 wherein the content portal page includes a plurality of criteria;
wherein each of the plurality of content files includes meta data; and
wherein the meta data associated with the plurality of content files are checked against the plurality of criteria to determine the one or more of the plurality of content files.

24. The system of claim 23 wherein the client is further configured to create the personalized program based on the respective meta data associated with the one or more of the plurality of content files.

25. The system of claim 22 wherein execution of the personalized program is dynamic and is based on one or more factors.

26. The system of claim 25 wherein the one or more factors include time.

27. The system of claim 25 wherein the one or more factors include location of the client.

28. The system of claim 22 wherein the client includes one of a mobile device and a personal computer.

29. A system for providing customized audio/video (A/V) and animation programming over a network, the system comprising:
a plurality of servers, each server configured to store a plurality of content files, each of the plurality of content files including A/V and/or animation data;
wherein a first one of the plurality of servers is configured to:
receive the content portal page;
create a personalized program based on the content portal page, the personalized program including one or more content files retrieved from the plurality of servers; and
transmit the personalized program; and
a client configured to:
allow a user to specify the content portal page;
transmit the content portal page to the first one of the plurality of servers;
receive the personalized program; and
execute the personalized program for consumption by the user;
wherein the personalized program is executed such that the one or more content files included in the personalized program are shown to the user in a continuous manner.

30. The system of claim 29 wherein the content portal page includes a plurality of criteria;
wherein each of the plurality of content files includes meta data; and
wherein the meta data associated with the plurality of content files are checked against the plurality of criteria to determine the one or more content files included in the personalized program.

31. The system of claim 30 wherein the server is further configured to create the personalized program based on the respective meta data associated with the one or more content files.

32. The system of claim 29 wherein execution of the personalized program is dynamic and is based on one or more factors.

33. The system of claim 32 wherein the one or more factors include time.

34. The system of claim 32 wherein the one or more factors include location of the client.

35. The system of claim 29 wherein the client includes one of a mobile device and a personal computer.
